(19) United States
(12) Patent Application Publication
(10) Pub. No.: US 2014/0200056 A1
(43) Pub. Date: Jul. 17, 2014

(54) CELL PHONE PROTECTIVE SHELL WITH HOLDER

(71) Applicant: WTL (USA) Fund, Inc., Walnut, CA (US)

(72) Inventor: Tak Nam Liu, Shenzhen (CN)

(21) Appl. No.: 14/153,694

(22) Filed: Jan. 13, 2014

(30) Foreign Application Priority Data
Jan. 11, 2013 (CN) 201320014369.9

(51) Int. Cl. H04M 1/04; H04B 1/38

(52) U.S. Cl. CPC H04M 1/04; H04B 1/3888
USPC 455/575.8

(57) ABSTRACT

A smart phone protective shell with a holder, comprising a cavity formed by a bottom plate and a main framework; and characterized in that it further comprises a bracket, wherein the support plate with a clamping block of the bracket is connected to the first transverse frame of the surface frame through a side connecting plate; a support block is formed on the second transverse frame of the surface frame; a notch is set in the first transverse side plate of said main framework to adapt to the side connecting plate; a notch is set in the second transverse side plate of the main framework to adapt to the support block; a support plate recess with a clamping slot is formed on the back side of said bottom plate; said surface frame is detachably clamped in the main framework; said support plate is clamped in said support plate recess; said side connecting plate is clamped in said side connecting plate notch; and said support block is clamped in said support block notch. In this way, the present invention solves the problem of instable support and inconvenience in hand-held use with the prior art.

### CROSS-REFERENCE

This application claims priority to and the benefit of the filing date of Chinese Patent

Application No. 201320014369.9, filed Jan. 11, 2013, the contents of which are incorporated herein by reference.

### TECHNOLOGICAL FIELD

The present invention relates to mobile device protective devices, and more particularly to a cell phone protective shell with a holder.

### BACKGROUND

With the development of electronic technologies, mobile electronic products have developed at a remarkably high speed. Regarding a cell phone, for example, it has developed from a mere call receiving device to become a multifunctional smart computing device today. The price of a cell phone witnesses a sharp increase as well. Today, the price of a high-end cell phone is equal to that of a notebook computer. Due to its high price, people take more care of their cell phones. As a result, it has almost become a common practice to provide a smart phone with a protective shell. A cell phone protective shell according to prior art usually comprises a bottom plate, with upright side plates set on four sides of the bottom plate to form a cavity on the bottom plate. A cell phone is placed in the cavity. Since a smart phone can play videos, it has to be placed in a slanting position on a desk sometimes to help the user watch videos for a long time. To solve this problem, a number of devices have been introduced for a cell phone protective shell with a holder. Based on these devices, the structure is basically adding a support bar to the back side of the bottom plate of the protective shell. The support bar can be unfolded to support the cell phone on a desktop. A problem with the prior art is that the support is instable because the support structure has only one support point. Moreover, the support bar attached to the back of the bottom plate of the protective shell protrudes from the rear surface of the bottom plate, which adversely affects the comfort of the hand holding the cell phone and causes inconvenience. Therefore, it is desired to make an improvement on the prior art, such as to address one or more of the problems identified above.

### BRIEF SUMMARY

The present invention aims to overcome the problems with the prior art by providing a cell phone protective shell with a holder.

Certain embodiments of the present invention relate to a mobile device protective shell with a holder, comprising a bottom plate and a main framework, wherein said main framework is fixedly joined to the bottom plate to form a cavity configured to contain a mobile device; a bracket comprising a surface frame and a support plate, wherein said support plate is connected to the first transverse frame of said surface frame through a side connecting plate; a clamping block is formed on one end of said support plate; a support block is formed on the second transverse frame of said surface frame; wherein said main framework comprises a first transverse side plate and a second transverse side plate; a notch is set in said first transverse side plate to adapt to said side connecting plate; a notch is set in said second transverse side plate to adapt to the support block; a support plate recess is formed upwardly from the position of the notch for the connecting plate on the back side of said bottom plate; and a clamping slot is formed in the upper part of said support plate recess to mate said clamping block, wherein said surface frame is detachably clamped in the main framework, wherein said support plate is clamped said support plate recess, wherein said side connecting plate is clamped in the notch for said side connecting plate, and wherein said support block is clamped in the notch for said support block. A mobile device protective shell may include two support blocks and two notches for the support blocks, and the two support blocks may be within a range of width defined by said side connecting plate.

Embodiments of the present invention also relate to a cell phone protective shell with a holder comprising a bottom plate and a main framework, wherein said main framework is fixedly joined to the bottom plate to form a cavity, and said cell phone is contained in said cavity. It is characterized in that it further comprises a bracket, wherein said bracket comprises a surface frame and a support plate, and said support plate is connected to the first transverse frame of said surface frame through a side connecting plate; a clamping block is formed on one end of said support plate; a support block is formed on the second transverse frame of said surface frame; the main framework comprises a first transverse side plate and a second transverse side plate; a notch is set in said first transverse side plate to adapt to said side connecting plate; a notch is set in said second transverse side plate to adapt to the support block; a support plate recess is formed upwardly from the notch for the connecting plate on the back side of said bottom plate; a clamping slot is formed in the upper part of said support plate recess to mate said clamping block; said surface frame is detachably clamped in the main framework; said support plate is clamped in said support plate recess; said side connecting plate is clamped in the notch for said side connecting plate; and said support block is clamped in the notch for said support block.

In the cell phone protective shell with a holder according to the present invention, the support block can be disengaged from the support block notch when the cell phone is placed in a slanting position on a desktop; further, the side connecting plate may be disengaged from the side connecting plate notch so that all parts except for the clamping block and the clamping slot are disengaged from the support plate recess; moreover, one side of the first transverse side plate of the main framework of the cell phone protective shell according to the present invention is placed on the support block of the second transverse side frame, and the surface frame is on the desktop to create a valid support position and to enable the user to watch videos for a long time or perform other operations in a non-handheld mode. In the present invention, the entire surface frame touches the desktop to ensure a steady and reliable support; moreover, the support is fully engaged into the support plate recess when it is not in use to deliver the same comfort to hand as a conventional cell phone protective shell does. Therefore, the objective of the present invention is achieved. There may be two support blocks and two support block notches, and the two support blocks are within the range of width defined by the side connecting plate. Therefore, when it is in use, the second support block falls into the side connecting plate notch, which further enhances the stability of support.

These and other apparatus and method embodiments of the present disclosure are described further below.

### BRIEF DESCRIPTION OF THE DRAWINGS

Having thus described the invention in general terms, reference will now be made to the accompanying drawings, which are not necessarily drawn to scale, and wherein:

FIG. 1 is a structural schematic diagram of a cell phone protective shell with a holder according to an embodiment of the present invention;

FIG. 2 is a first exploded view of a cell phone protective shell with a holder according to an embodiment of the present invention;

FIG. 3 is a second exploded view of a cell phone protective shell with a holder according to an embodiment of the present invention;

FIG. 4 is an exploded view of a cell phone protective shell with a holder according to an embodiment of the present invention when it is in use;

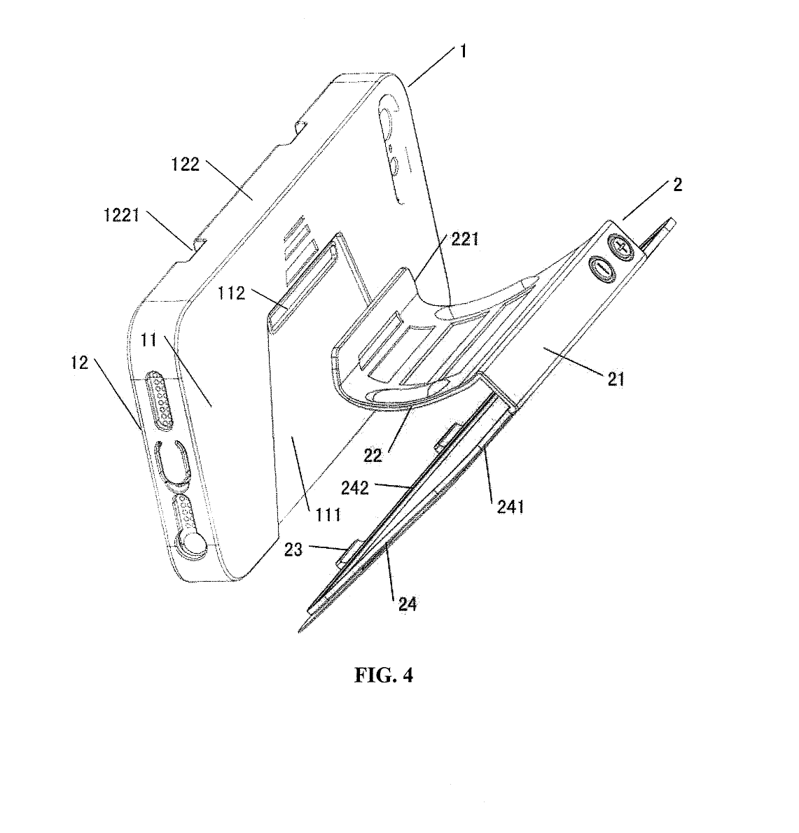

FIG. 5 is a diagram of a cell phone protective shell with a holder according to an embodiment of the present invention in the first usage state; and

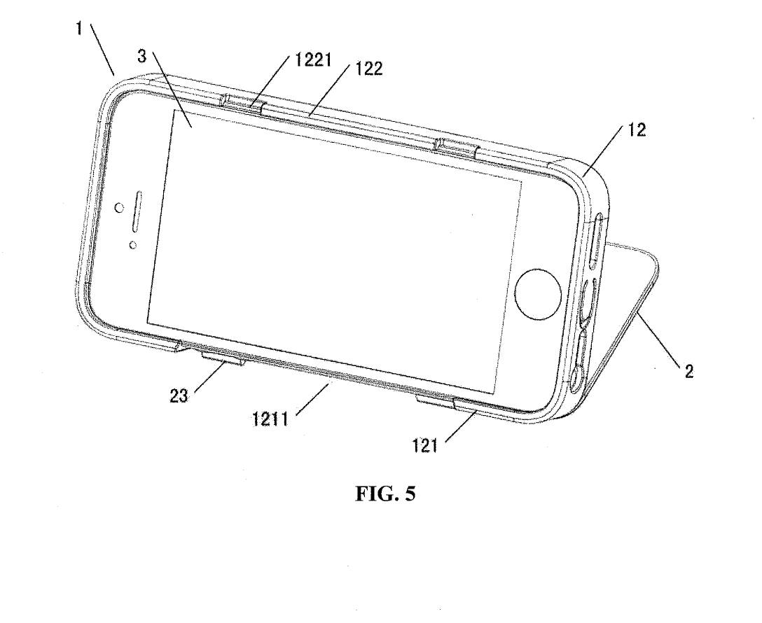

FIG. 6 is a diagram of a cell phone protective shell with a holder according to an embodiment of the present invention in the second usage state.

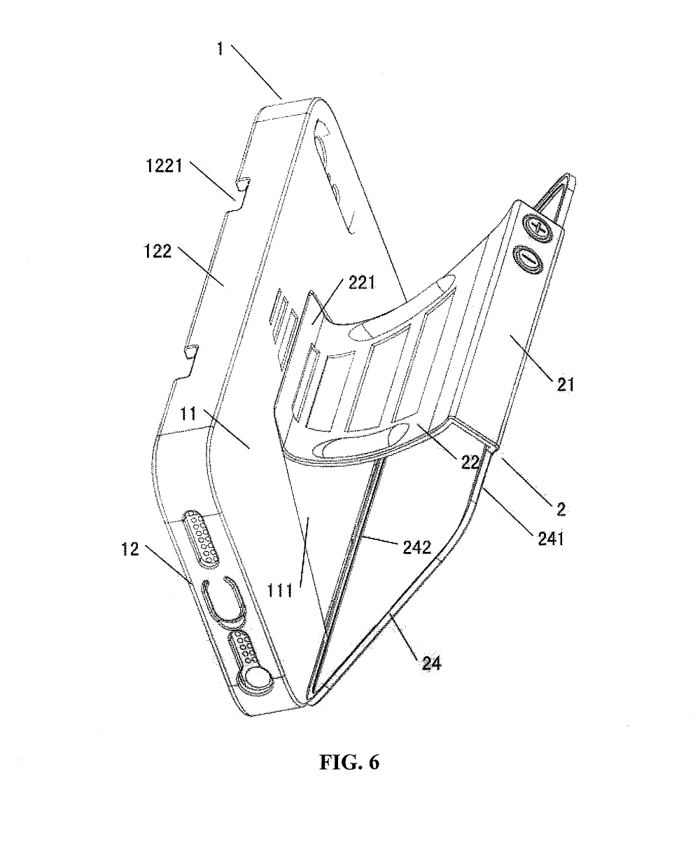

### DETAILED DESCRIPTION

Embodiments of the present disclosure now will be described more fully hereinafter with reference to the accompanying drawings, in which some, but not all embodiments are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout.

In the figures, the following numbers refer to the following elements:

1: Cavity;

11: Bottom plate;

111: Support plate recess;

112: Clamping slot;

12: Main framework;

121: First transverse side plate;

1211: Side connecting plate notch;

122: Second transverse side plate;

1221: Support block notch;

2: Bracket;

21: Side connecting plate;

22: Support plate;

221: Clamping block;

23: Support block;

24: Surface frame;

241: First transverse frame;

242: Second transverse frame; and

3: Cell phone.

The term cell phone is used herein for convenience to more generally refer to mobile devices including cell phones and smart phones that are portable computing devices, typically embodying cellular and/or wireless capabilities for communications and may commonly be carried on a user, such as in a hand, pocket, carry-bag, or purse. The term cell phone is not limited to a specific mobile device or a specific type of such mobile devices, but is used for convenience to refer herein to all such mobile devices and types of such mobile devices.

A further description of a cell phone protective shell with a holder according to the present invention is given below with reference to certain embodiments and corresponding drawing figures.

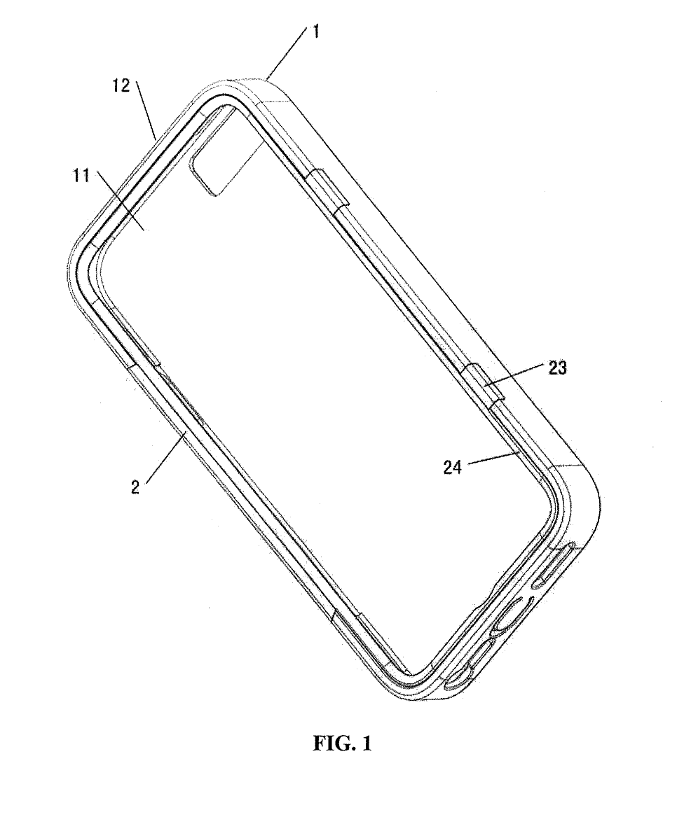

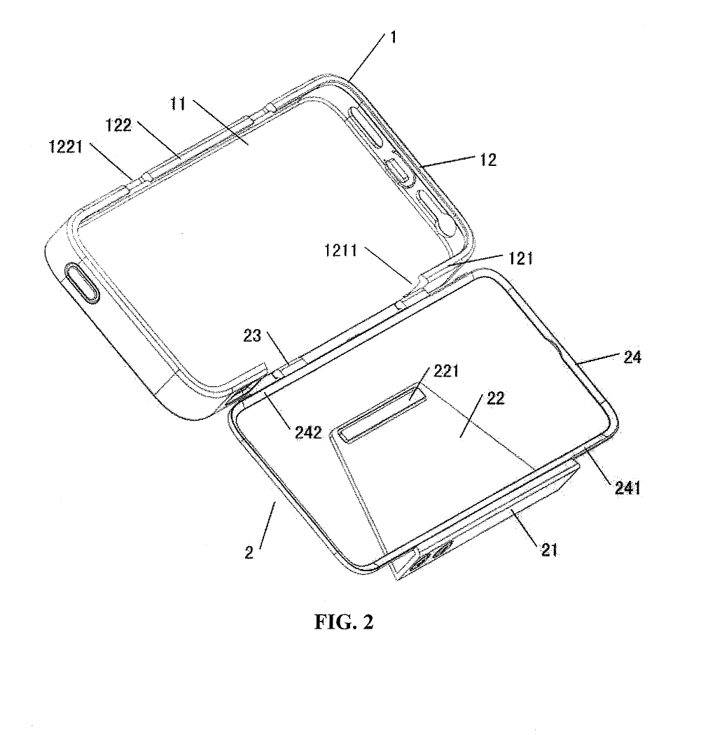

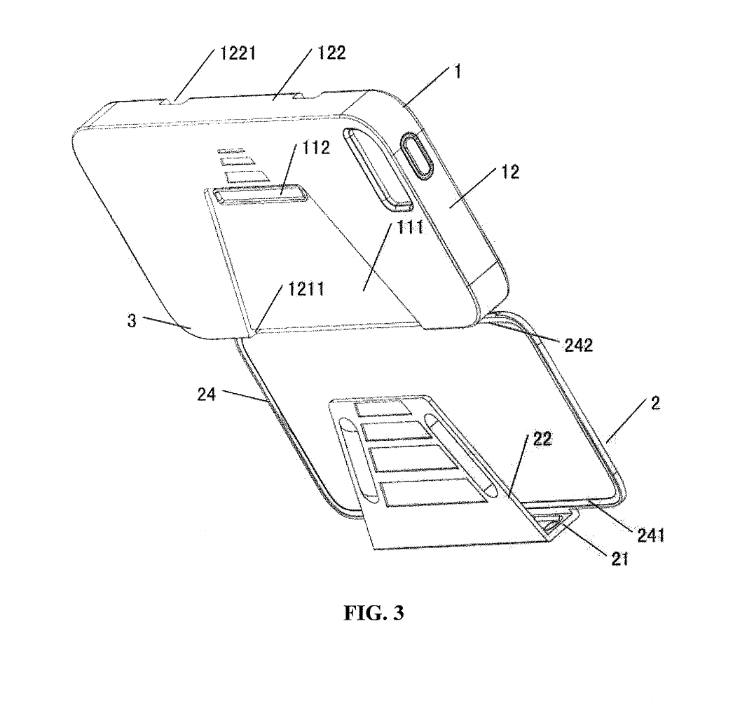

One embodiment of the present invention provides a cell phone protective shell with a holder as shown in FIGS. 1 through 3, comprising a bottom plate (11) and a main framework (12), wherein said main framework (12) is fixedly joined to the bottom plate (11) to form a cavity (1), and said cell phone (3) is contained in said cavity (1); and it is characterized in that it further comprises a bracket (2), wherein said bracket (2) comprises a surface frame (24) and a support plate (22), and said support plate (22) is connected to the first transverse frame (241) of said surface frame (24) through a side connecting plate (21); a clamping block (221) is formed on one end of said support plate (22); a support block (23) is formed on the second transverse frame (242) of said surface frame (24); said main framework (12) comprises a first transverse side plate (121) and a second transverse side plate (122); a notch (1211) is set in said first transverse side plate (121) to adapt to said side connecting plate (21); a notch (1221) is set in said second transverse side plate (122) to adapt to the support block; a support plate recess (111) is formed upwardly from the position of the connecting plate notch (1211) on the back side of said bottom plate (11); a clamping slot (112) is formed in the upper part of said support plate recess (111) to mate said clamping block (221); said surface frame (24) is detachably clamped in the main framework (12); said support plate (22) is clamped in said support plate recess (111); said side connecting plate (21) is clamped in said side connecting plate notch (1211); and said support block (23) is clamped in said support block gap (1221).

In this embodiment, there are two support blocks (23) and two support block gaps (1221), and said two support blocks (23) are within the range of width defined by said side connecting plate (21).

Embodiments of the present invention relate to a cell phone protective shell with a holder, comprising a cavity formed by a bottom plate and a main framework; and it is characterized in that it further comprises a bracket, wherein the support plate with a clamping block of the bracket is connected to the first transverse frame of the surface frame through a side connecting plate; a support block is formed on the second transverse frame of the surface frame; a notch is set in the first transverse side plate of the main framework to adapt to the side connecting plate; a notch is set in the second transverse side plate of the main framework to adapt to the support block; a support plate recess with a clamping slot is formed on the back side of the bottom plate; the surface frame is detachably clamped in the main framework; the support plate is clamped in the support plate recess; the side connecting plate is clamped in the side connecting plate notch; and the support block is clamped in the support block notch. In this way, the present invention solves the problems of instable support and inconvenience in hand-held use with the prior art.

The above only describes certain embodiments of the invention. The protection scope if the invention is not limited to the foregoing description. Many modifications and other embodiments of the present disclosure set forth herein will come to mind to one skilled in the art to which these embodiments pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mobile device protective shell with a holder, comprising:
a bottom plate and a main framework, wherein said main framework is fixedly joined to the bottom plate to form a cavity configured to contain a mobile device;
a bracket comprising a surface frame and a support plate, wherein said support plate is connected to the first transverse frame of said surface frame through a side connecting plate;
a clamping block is formed on one end of said support plate;
a support block is formed on the second transverse frame of said surface frame;
wherein said main framework comprises a first transverse side plate and a second transverse side plate;
a notch is set in said first transverse side plate to adapt to said side connecting plate;
a notch is set in said second transverse side plate to adapt to the support block;
a support plate recess is formed upwardly from the position of the notch for the connecting plate on the back side of said bottom plate; and
a clamping slot is formed in the upper part of said support plate recess to mate said clamping block,
wherein said surface frame is detachably clamped in the main framework,
wherein said support plate is clamped said support plate recess,
wherein said side connecting plate is clamped in the notch for said side connecting plate, and
wherein said support block is clamped in the notch for said support block.

2. The mobile device protective shell with a holder according to claim 1, wherein there are two support blocks and two notches for the support blocks, and said two support blocks are within a range of width defined by said side connecting plate.

3. A cell phone protective shell with a holder, comprising a bottom plate and a main framework, wherein said main framework is fixedly joined to the bottom plate to form a cavity, and said cell phone is contained in said cavity; is characterized in that it further comprises a bracket, wherein said bracket comprises a surface frame and a support plate, and said support plate is connected to the first transverse frame of said surface frame through a side connecting plate; a clamping block is formed on one end of said support plate; a support block is formed on the second transverse frame of said surface frame; said main framework comprises a first transverse side plate and a second transverse side plate; a notch is set in said first transverse side plate to adapt to said side connecting plate; a notch is set in said second transverse side plate to adapt to the support block; a support plate recess is formed upwardly from the position of the notch for the connecting plate on the back side of said bottom plate; a clamping slot is formed in the upper part of said support plate recess to mate said clamping block; said surface frame is detachably clamped in the main framework; said support plate is clamped said support plate recess; said side connecting plate is clamped in the notch for said side connecting plate; and said support block is clamped in the notch for said support block.

4. The cell phone protective shell with a holder according to claim 3, wherein there are two support blocks and two notches for the support blocks, and said two support blocks are within a range of width defined by said side connecting plate.
